(19) United States
(12) Patent Application Publication
(10) Pub. No.: US 2026/0133753 A1
(43) Pub. Date: May 14, 2026

(54) METHOD FOR REAL-TIME HAPTIC FEEDBACK ON PORTABLE DEVICES SUCH AS PHONES, DEPENDING ON THE INTENSITY OF THE SOUND ENVIRONMENT

(71) Applicant: Damien Quintard, Paris (FR)

(72) Inventor: Damien Quintard, Paris (FR)

(21) Appl. No.: 18/941,056

(22) Filed: Nov. 8, 2024

(51) Int. Cl. G06F 3/16; H04R 3/04

(52) U.S. Cl. CPC G06F 3/167; H04R 3/04; H04R 2400/03

(57) ABSTRACT

A method of controlling vibration intensity of a haptic motor as a function of a digitized audio signal, wherein the audio signal is picked up by a microphone or comes from an audio source, comprises cyclic repetition, in real time, of the following steps: digital audio signal reception; computer processing of the digital audio signal to determine actual sound intensity or pressure; and controlling the vibration intensity of the haptic motor as a function of sound pressure level, with amplitude proportional to the determined sound pressure level.

### TECHNICAL FIELD

The present disclosure relates to the field of enhanced sensory immersion, by adding haptic vibrations based on ambient music or sounds.

### BACKGROUND

Haptic vibrations combined with music or ambient sounds immerse users in a multi-sensory experience, increasing engagement and immersion. By adding real time tactile feedback to an auditory experience, users physically feel the music, reinforcing the perceived emotion. Haptic effects synchronized with musical elements can amplify the emotions associated with music, as the body naturally reacts to vibrations. This synchronization can accentuate certain musical passages (such as power ups or crescendos), creating a stronger emotional connection with the user.
Video games and interactive experiences: In games or films, haptic vibrations synchronized with explosions, blows or sound events enhance immersion and make the experience more realistic and captivating.
Virtual concerts or music applications: users can feel the beats or low frequencies of the music, giving them a sensation akin to a live concert.

Haptic vibrations based on music or ambient sounds can also be very useful for hearing-impaired or deaf people, enabling them to feel music or be alerted by sound events. This tactile integration helps compensate for the absence of auditory perception, making music and sound experiences more inclusive.
Translating sound into vibration: Hearing-impaired people can enjoy music or surrounding sounds through vibrations, enabling them to feel the rhythms and frequencies of sounds they can't hear.
Sound alert converted to vibration: In noisy environments or for people with hearing impairments, vibrations can signal important sounds, such as alarms or notifications.

Combining tactile sensations with audio can improve memory and information retention. When a sound event is accompanied by vibration, it becomes more memorable. This is particularly useful in contexts such as important notifications, where haptic feedback synchronized with sound can better capture the user's attention.
Notifications: A vibration associated with a particular sound can help users to quickly identify the importance of the notification without the need to visually consult their device.

Synchronizing vibrations with music or ambient sounds creates unique, personalized experiences. Developers can design original interactions that go beyond simple sound, exploiting the ability of devices to deliver physical sensations through vibrations.
Immersive experiences in virtual reality (VR): In immersive environments such as VR, vibrations synchronized with sound events can simulate physical sensations and enhance the perception of immersion.
Personalized musical experiences: some applications allow haptic feedback to be customized to the user's musical preferences, enhancing the originality and personalization of the experience.
Motivation and support in health and fitness applications.

In the field of fitness and health, haptic vibrations synchronized with musical tempo can serve as a means of motivation, helping users to keep pace or achieve their goals.
Haptic feedback during workouts: Vibrations set to the tempo of the music can urge users to maintain their pace during cardio or running sessions, boosting performance.
Guidance in breathing exercises: In health or meditation applications, vibrations can guide users through breathing exercises synchronized with relaxing music, enhancing their well-being.

Generating haptic vibrations in response to music or ambient sounds brings many benefits: it enhances sensory immersion, increases emotional engagement, improves accessibility, and enriches user interactions. These haptic effects add a tactile dimension to audio, enabling users not only to listen, but also to feel the music, creating more captivating and inclusive multi-sensory experiences. Whether in music applications, video games, notifications or healthcare contexts, haptic synchronization with sounds and music opens up new possibilities for interaction and engagement.

### State of the Art

The synchronization of haptic vibrations with music or ambient sounds can be achieved through solutions ranging from mobile applications and wearable hardware devices to software for developers.

Some applications that run on a smartphone allow haptic vibrations to be synchronized with music or ambient sounds. These solutions are often used to enhance users' immersive experience, be it music, games or relaxation.

For example, patent US20200249758 describes a method of accessing audio data, obtaining tactile audio data associated with the audio data and, while reproducing the audio data, reproducing a tactile audio response based on the tactile audio data in a manner customized for a user. The tactile audio data can be reproduced via an electroactive transducer to transfer the tactile audio response to the user's body. Another method may involve obtaining audio data, analyzing the audio data to identify an audio component that comprises an audio layer or an audio source, and identifying an audio attribute of the audio component. The method may also involve selecting the audio component to accompany a tactile audio response, generating tactile audio data that describes the tactile audio response for the selected audio component, and coordinating the tactile audio data of the selected audio component with the audio data of the selected audio component.

U.S. Pat. No. 11,340,704B2 describes another solution for optimizing a customized touch output consisting of receiving an audio signal, decomposing the audio signal to identify one or more components of the audio signal; generating, by an artificial intelligence system, a touch signal based on one or more components of the audio signal, the touch signal representing the touch audio corresponding to the audio signal; supplying the generated touch signal to a touch device for producing the touch audio; in response to the generated touch signal, receiving feedback; and modifying the touch signal parameters in response to the received feedback based on a use case of the touch device for reproducing the touch signal.

Patent application WO2024127005A1 describes an alternative solution for generating haptic signals from audio content, optimizing the user experience by combining tactile and sonic feedback. It enriches entertainment systems and enhances multi-sensory immersion by using haptic transducers to render vibrations based on the low frequencies of audio. The process involves a first stage of tactile signal extraction and algorithms to separate the audio signal into two components:
Transient signal: Relates to sudden or impulsive sound events (e.g., bass blasts).
Stable signal: represents the continuous vibration or rumble associated with low frequencies.

The transient and stable tactile signals are then sent to haptic transducers located in the seat, floor or wearable devices. Each transducer can receive one of the signals or a weighted combination of the two to optimize the tactile experience. To ensure perfect cohesion between the audio and haptic signals, a time correction is applied to align the vibrations with the perceived sounds, particularly when the transducers are placed at different distances from the user.

U.S. Pat. No. 10,210,724B2 describes a method of providing haptic feedback comprising the steps of:
receiving, at a user device, an input signal from a remote location, the input signal comprising a coded value, which encodes an actuator control value, the actuator control value corresponding to a force of a haptic effect;
convert, at the user device level, the coded value into an ON/OFF time model; and
read the ON/OFF duration pattern on an actuator in the user device to produce the haptic effect.

Prior art solutions are unsatisfactory because the perceived haptic feedback is not totally consistent with the actual perceived loudness.

### BRIEF SUMMARY

To overcome this drawback, the present disclosure relates to a method of controlling the vibration intensity of a haptic motor as a function of a digitized audio signal, characterized in that the audio signal is picked up by a microphone or comes from an audio source, the method comprising the cyclic repetition, in real time, of the following steps:
Digital audio signal reception;
Computer processing of the signal to determine actual sound intensity or pressure; and
Controlling the vibration of the haptic motor as a function of the sound pressure level, with the amplitude proportional to the determined sound pressure level.

According to a first variant, the computer processing comprises a classification of the sound level into several decibel ranges called “trunks,” each trunk corresponding to a specific range of dB levels, and each trunk being associated with a predetermined percentage of vibration intensity.

Advantageously, the association of decibel ranges with vibration percentages is defined by an artificial intelligence (AI) that analyzes the sound level in real time, identifies the corresponding trunk, and adjusts the vibration intensity of the haptic motor according to the identified trunk.

Preferably, each trunk represents a range of 10 decibels, with increasing levels of vibration, the trunk corresponding to the 0 to 10 dB range being associated with a vibration intensity of 5%, and the trunk corresponding to the maximum dB range being associated with a vibration intensity of 100%.

In one embodiment, computer processing uses the Root Mean Square (RMS) method to determine the average sound amplitude of the audio signal, by calculating the square root of the mean square of the audio samples.

Advantageously, the audio samples are grouped into data blocks called “buffers,” each sample being taken, squared and averaged before the square root is extracted to obtain the RMS value.

Preferably, the calculated RMS value is multiplied by a predetermined amplification factor, and adjusted to remain in a range between 0 and 1, where any negative value is set to zero and any value greater than 1 is set to 1.

In one variant, the haptic motor vibration intensity control is proportional to the adjusted RMS value or percentage of vibration corresponding to the decibel trunk within which the detected sound level lies.

In a particular embodiment, the haptic engine is integrated into a smartphone and vibrations are emitted in real time according to variations in the audio signal picked up by the phone's microphone or received from an external audio source.

### BRIEF DESCRIPTION OF THE DRAWINGS

The present disclosure will be better understood on reading the following description, concerning a non-limiting example of embodiment illustrated by the appended drawings where:

FIG. 1 shows a schematic representation of the general principle of the present disclosure.

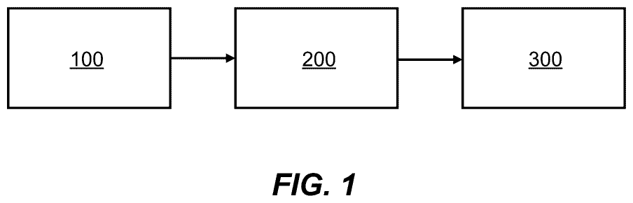

FIG. 2 shows a schematic representation of a first embodiment of the present disclosure.

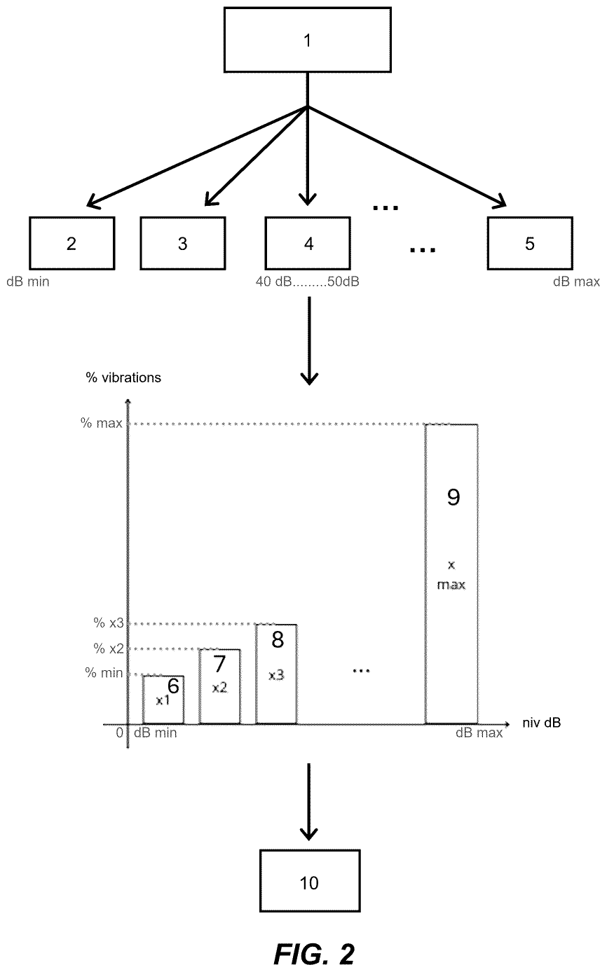

FIG. 3 shows a schematic representation of a second embodiment of the present disclosure.

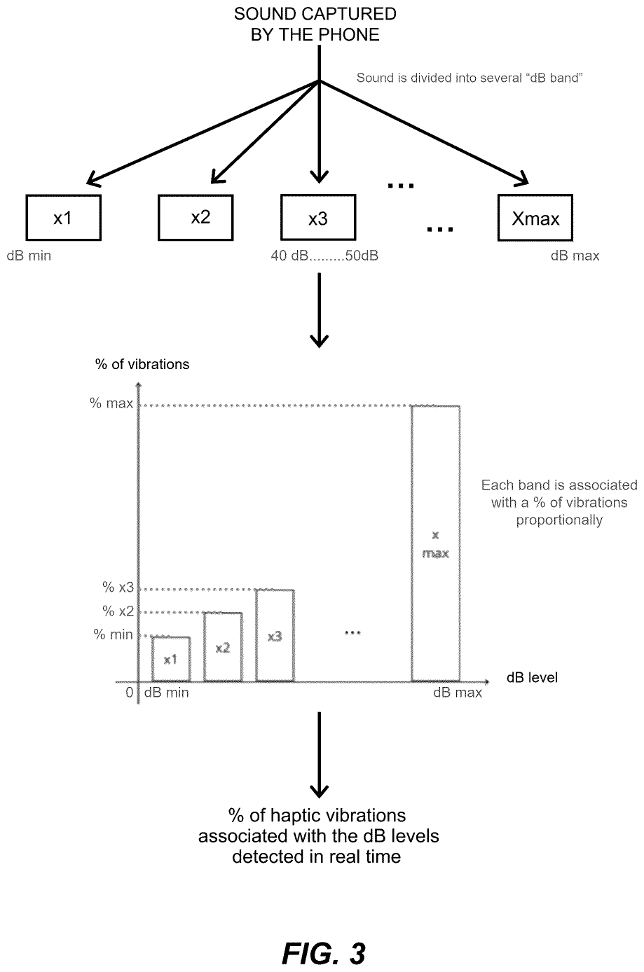

### DETAILED DESCRIPTION

The present disclosure combines real-time capture of the sound environment with haptic feedback on portable devices such as smartphones.

The process consists of determining the actual sound pressure by computer processing applied to the digital audio signal to control the vibration of the haptic motor in real time, cyclically, with a cycle time advantageously between 0.1 and 100 milliseconds, with an amplitude, during each cycle, depending on the actual sound intensity or sound pressure picked up by a microphone or from an audio input signal.

The actual sound pressure can be determined, for example, by artificial intelligence processing, or by RMS (Root Mean Square) processing.

### General Description

The following technical description presents a solution for real-time haptic feedback on a wearable device based on the sound environment that captures sounds from the environment, analyzes them in real time, and adjusts the wearable device's haptic feedback to reflect the perceived loudness. The system is flexible and can be customized to suit a variety of use scenarios, from making noisy environments more perceptible to enhancing interaction with the sound world for hearing-impaired users, for example.

### General System Architecture

The system consists of three main modules:
Sound capture module (100): This module uses the device's built-in microphone to capture sound from the environment in real time, or a signal-processing module.
Signal processing module (200): This module analyzes the captured sound, extracts the relevant characteristics (such as intensity, frequency or sound classification) and converts them into a value that can be used to adjust the haptic vibrations by setting a vibration amplitude representative of the acoustic intensity or pressure for the duration of the cycle.
Haptic feedback module (300): This module controls haptic feedback based on data transmitted by the signal processing module. It activates the device's built-in vibration motor to provide real-time feedback.

The sound capture module (100) comprises the:
An audio sensor: Using the device's built-in microphone to capture ambient sounds. It can operate in passive or active mode, depending on the application, and must support a broad spectrum of sound frequencies (20 Hz to 20 kHz).

Or optionally an electronic circuit receiving an audio signal as input.
Real-time audio acquisition: The audio signal is captured continuously at a sampling rate high enough to accurately capture the sound environment (typically between 44.1 kHz and 96 kHz).

Access to a smartphone's hardware components is achieved by using the sound capture APIs available on Android or iOS systems. For example:
Android™: MediaRecorder™ or AudioRecord™.
iOS™: AVCaptureAudioDataOutput™ or AVAudioRecorder™.

The signal processing module (200) performs the following functions:
Noise filtering: Application of low-pass and high-pass filters to eliminate unwanted frequencies and clean up audio data. Algorithms such as Fast Fourier Transform (FFT) can be used to analyze the frequency content of the signal.
Spectral analysis: The system analyzes frequency bands to determine the nature of the sound (bass, treble, etc.) and the sound intensity (measured in decibels, dB).
Segmentation of sound intensity: The captured sound is segmented into several intensity levels (e.g., low, medium, high), and each segment is associated with a specific haptic feedback.
Haptic adjustment decision: Processed data can be used to determine how haptic feedback will be modulated. For example, a louder or more percussive sound will trigger more intense or more frequent vibrations.
Implementing the haptic feedback algorithm:
   Amplitude Mapping: Sound intensity is mapped to vibration amplitude.
   Frequency Mapping: Specific sound frequencies can be mapped to unique vibration patterns (fast vibration for high tones, slow vibration for low tones).
   Response time: The algorithm must be optimized to respond in less than 100 ms, guaranteeing real-time feedback.

The haptic feedback module (300) performs the following functions:
Haptic engine control: this module sends commands to the phone's vibration engine (such as the Taptic Engine™ on iPhone™ or the linear vibration engines on Android™). These motors must be able to produce a range of haptic sensations depending on the commands received.
Vibration API: Use native APIs to generate vibrations on the device.
   Android™: Vibrator class (vibrate( ) method).
   iOS™: UIImpactFeedbackGenerator or UINotificationFeedbackGenerator.
Vibration modulation:
   The vibration is modulated according to the intensity and frequency of the sound picked up.
   Pre-defined vibration patterns can be used (such as “pulse” or “wave” vibrations) to better reflect the nature of the sound captured.

### d) User Interface and Customization Options

Control interface: A user interface lets you configure system parameters, such as microphone sensitivity or desired haptic feedback types (low, medium, high).
Sound visualization: An option to visually display sound levels captured in real time could be integrated, with graphs or level bars.
Vibration customization: The user can choose different types of haptic feedback depending on the types of sounds detected (for example, choose a specific type of vibration for high or low-pitched sounds).

### 3. Operating Example

When the user is on a very noisy street (high sound intensity, >80 dB), the phone may generate strong, continuous vibrations to reflect the loudness.
In a quieter environment (low noise level, <50 dB), the phone may generate gentle, intermittent vibrations.
If specific frequencies are detected (e.g., high-pitched noises or alarms), the system may vibrate faster or at a particular frequency.

### 4. Resource Optimization and Management

Power consumption: The module must be optimized to minimize power consumption, as continuous use of the microphone and haptic motor can drain the battery quickly.
Background processing: The system should operate in the background, capturing and processing sounds without interrupting normal phone use. Context-sensitive notifications can be sent to the user when significant changes in the sound environment are detected.

### 5. Extensions and Advanced Features

Supervised learning for sound analysis: A machine learning model could be used to identify specific types of sound (voice, traffic, music, etc.) and adjust haptic feedback, accordingly.
Integration with external devices: The system could be extended to work with headphones or haptic wristbands, offering an even more immersive experience.
Augmented reality: In the near future, this system could be integrated into augmented reality environments, enabling the user to receive haptic signals based on virtual or real sounds.

Processing is carried out in real time, cyclically, with cycle times ranging from 0.1 to 100 milliseconds, for example, and more generally according to the duration of a haptic motorcycle.

The cycle time for a real-time, intensity-based haptic feedback solution depends on a number of technical factors relating to the capture and processing of audio data, and the generation of the haptic effect.

Typically, to guarantee a “real-time” haptic response, the complete cycle, which includes sound capture, data analysis (intensity and frequency), and generation of the haptic vibration, needs to be fast, generally less than 100 ms. This delay ensures that the user perceives the vibration almost immediately after the sound change is detected.

Cycle components include:
Sound capture: Approx. 10-20 ms, depending on audio sampling rate.
Signal processing: Sound processing (via FFT algorithms or other signal processing methods) takes around 10 to 30 ms, depending on the complexity of the analyses to be carried out.
Generation of haptic effect: Approx. 10 to 50 ms, depending on the intensity and modulation of the vibration required.

Overall, the total duration of a haptic feedback cycle could be between 30 ms and 100 ms. This enables a smooth, reactive response to sound variations in the environment.

### First Variant

The aim of this first variant is to adapt the intensity of the vibrations applied by a phone's haptic motor as a function of an audio signal, for example, as a function of the sound levels detected by the phone's microphone. This process is based on a segmentation of the sound signal into different decibel (dB) levels (2 to 5), with a percentage of vibration associated with each range, thus enabling vibrations to be adapted to sound variations. The process comprises a first step (1) of sound capture. The phone's microphone picks up ambient sound in the form of a digital audio signal. This signal is then processed to measure the decibel (dB) level corresponding to actual sound pressure. A device's microphone picks up ambient sound and converts it into digital signals that the application can process. Sound intensity is measured in dB, a logarithmic unit that reflects the power of sound perceived by the human ear.

According to this variant, this processing is carried out by AI (artificial intelligence) processing used to analyze the audio signal and determine the dB level corresponding to each instant. This dB level reflects the intensity of the sound perceived by the microphone.

AI segments sound levels into several trunks or ranges. Segmenting decibel (dB) levels involves dividing a range of measured sound levels into different categories or “bands” of values (6 to 9), each covering a certain dB interval. This makes it possible to associate each interval with a certain level of response or action, for example:
The first trunk X₁ covers the range from 0 to 10 dB.
The second trunk X₂ covers the range from 10 to 20 dB, and so on up to the maximum range.
Segmentation continues until Xₘₑₓ, which corresponds to the maximum dBmax level that can be detected.

Each trunk represents a defined dB range, enabling simplified management of sound intensity. The application or algorithm analyzes the measured dB level in real time. This can be done by measuring the sound pressure level (SPL) over a given period to obtain a stable measurement.

The next step is to associate a vibration percentage: for each dB trunk, a vibration percentage is defined by the AI. For example:
X₁ (0 -10 dB) is associated with 5% of the maximum vibration intensity.
X₂ (10-20 dB) is associated with 10% of the vibration intensity.
X₃ (20-30 dB) is associated with 15%, etc., up to XmaxX_{max}Xmax, which is associated with 100% of the vibration intensity.

The AI determines in real time the trunk to which the dB level belongs, and adjusts the haptic motor's vibration percentage according to this trunk.

Once the dB trunk has been identified by the AI and the vibration percentage determined, the phone adjusts the haptic motor's vibration intensity (10), accordingly.

So, if the sound level is low (for example, in trunk X1X_1X1), the haptic motor will emit a low vibration (5%), whereas for a louder sound (for example, in trunk XmaxX_{max}Xmax), the vibration will be maximum (100%).

In a nutshell:
The microphone captures ambient sound.
AI segments sound levels into dB trunks.
A vibration percentage is assigned to each trunk.
The haptic motor adjusts the intensity of the vibrations according to the identified trunk.

This method enables the vibration intensity to be fine-tuned in real time according to the ambient noise, providing a more immersive user experience that is responsive to sound variations.

### Second Variant

The second variant uses RMS processing to analyze and adjust the phone's vibrations in real time to the ambient sound. This method enables reliable measurement of average sound intensity, while ensuring that vibrations remain consistent and adapted to perceived sound pressure variations. RMS (root-mean-square) processing is used to determine the RMS value, i.e., the root-mean-square of a signal.

As in the first variant, the process comprises a first step (1) in which the phone's microphone picks up ambient sound and converts it into a digital audio signal. This signal is represented in the form of discrete samples at regular time intervals.

Each sample of the signal is a numerical value that generally oscillates between −1 and 1, representing the amplitude of the sound wave at that precise moment.

The next step (10) is to group the samples into buffers. The audio signal samples are grouped into buffers. The buffer size, i.e., the number of samples contained in a buffer, can be adjusted according to processing requirements. Typically, a buffer could contain several milliseconds of audio samples.

RMS processing is then performed for each buffer.

For each sample buffer, an RMS (Root Mean Square) calculation is performed. The calculation is performed in the following steps:
1. Squaring: Each sample in the buffer is squared, making all values positive, whether the amplitude is initially negative or positive.
2. Average of squares: The average of these square values is then calculated, which gives an idea of the overall signal strength in this buffer.
3. Square root: Finally, the square root of this average is extracted to obtain the RMS value, which represents the average sound amplitude of the signal in the buffer.

RMS processing calculates a reliable measure of the perceived average intensity of the audio signal, which is less sensitive to rapid variations and momentary peaks.

Once the RMS value has been obtained, it is multiplied by a factor of 5. This factor can be adjusted according to the specific needs of the device to amplify the detected sound intensity, as otherwise the vibration values were considered too low.

The new adjusted RMS value may exceed 1, or in some cases be negative (although this is rare with RMS calculation). Adjustment rules are applied to ensure that the final value lies between 0 and 1:
If the value is negative, it is reset to zero.
If the value exceeds 1, it is reset to 1.

Once set (between 0 and 1), this value is used to determine the vibration intensity (10) of the phone's haptic motor. The higher the RMS value, the stronger the vibration intensity.

The haptic motor adjusts its vibrations according to the overall sound level calculated from the RMS, providing tactile feedback proportional to the intensity of the ambient sound.

In a nutshell:
The phone picks up ambient sound through its microphone.
The audio signal is divided into buffers containing several sound samples.
For each buffer, the RMS is calculated to obtain a measure of the average amplitude of the sound.
This RMS value is multiplied by a factor of 5 and adjusted to remain between 0 and 1.
The final value is used to adjust the vibration intensity of the phone's haptic motor.

RMS processing is a simple, fast-to-calculate algorithm requiring few resources, making it ideal for real-time processing on a cell phone. RMS processing provides a stable measure of sound intensity, enabling the haptic engine to deliver a tactile response proportional to the amplitude of the sound without being disturbed by instantaneous fluctuations.

The multiplicative factor (for example, the factor of 5) can be adjusted to suit user preferences or environmental conditions, offering flexibility in the way vibrations are experienced.

The present disclosure concerns a method for enriching audiosignals. In particular, a real-time translation of the audio signal into vibrations linked to the haptic generators of a telephone.

### Adaptation to the Taptic Engine™

An example of adaptation between this technology and already existing haptic algorithms in current smartphones is described below.

Adaptation of the present disclosure concerning a real-time haptic feedback solution to the Taptic Engine™ is achieved using iOS™ haptic APIs to realize efficient processing of sound data, and fine management of haptic parameters to match the characteristics of the sound environment.

Sound capture and data processing is achieved by using the phone's built-in microphone to capture the sound environment. This can be achieved by using APIs such as AVAudioRecorder (on iOS) to record and process ambient sounds. Once the sound has been captured, the present disclosure involves real-time processing to analyze sound intensity (in decibels) and frequencies. Algorithms such as Fast Fourier Transform (FFT) can be used to identify frequency bands and determine the loudness in each band.

Processing must be fast, optimized to provide the information needed to activate haptic feedback in just a few milliseconds (generally less than 100 ms to guarantee instant feedback).

The next step is to calculate the amplitude of the haptic effects as a function of the sound signals. Once the sound data has been processed, the results must be mapped onto vibration patterns specific to the Taptic Engine™. For example:

Low, soft sounds can trigger gentle, slow vibrations.

High-pitched, intense sounds can trigger rapid, more pronounced vibrations, the amplitude of which depends on the intensity of the audio signal.

The Taptic Engine™ is capable of generating a wide range of subtle haptic effects, so you can adjust the duration, intensity and frequency of the vibrations according to the data received from the microphone.

Processing is carried out, for example, using specific APIs for the Taptic Engine in iOS™, such as:

UIImpactFeedbackGenerator: Generates vibrations corresponding to light or heavy impacts.

UINotificationFeedbackGenerator: For notifications with different types of haptic feedback (success, warning, failure).

UISelectionFeedbackGenerator: Provides haptic feedback when interacting with selections (e.g., a scrolling cursor).

These APIs can be integrated into the application so that vibrations are triggered according to the sound events captured and processed.

The Taptic Engine has an almost instantaneous response (<10 ms) to the vibration command. It is essential to ensure that the whole process, from sound capture to vibration, is optimized so that the time lag between the sound change and the haptic response is imperceptible to the user (typically less than 100 ms).

Techniques such as pre-loading haptic models to reduce latency when rapid changes in the sound environment are detected may also be employed.

For example, the application continuously monitors the intensity of ambient noise. If a sudden noise is detected, such as a horn or alarm (loud, high-frequency sound), it instantly triggers a strong vibration via the Taptic Engine. If the ambient noise is constant but low, it could provide softer, continuous vibrations, creating an immersive experience sensitive to the sound environment.

### 6. Personalization and User Interaction

It is also possible to allow the user to customize haptic feedback levels according to sound type or perceived loudness. This could be done via a user interface that adjusts vibration intensity and frequency parameters.

What is claimed is:

1. A method of controlling vibration intensity of a haptic motor as a function of a digitized audio signal, wherein the audio signal is picked up by a microphone or comes from an audio source, the method comprising cyclic repetition, in real time, of the following steps:
digital audio signal reception;
computer processing of the digital audio signal to determine actual sound intensity or pressure; and
controlling the vibration intensity of the haptic motor as a function of sound pressure level, with amplitude proportional to the determined sound pressure level.

2. The method of claim 1, wherein the computer processing comprises a classification of the sound pressure level into several trunks of decibel ranges, each trunk corresponding to a specific range of dB levels, and each trunk being associated with a predetermined percentage of vibration intensity.

3. The method of claim 2, wherein the association of the decibel ranges with the vibration intensity percentages is defined by an artificial intelligence that analyzes the sound pressure level in real time, identifies a corresponding trunk, and adjusts the vibration intensity of the haptic motor as a function of the identified trunk.

4. The method of claim 3, wherein each trunk represents a range of 10 decibels, with increasing vibration levels, a trunk corresponding to the 0 to 10 dB range being associated with a vibration intensity of 5%, and a trunk corresponding to the maximum dB range being associated with a vibration intensity of 100%.

5. The method of claim 2, wherein each trunk represents a range of 10 decibels, with increasing vibration levels, a trunk corresponding to the 0 to 10 dB range being associated with a vibration intensity of 5%, and a trunk corresponding to the maximum dB range being associated with a vibration intensity of 100%.

6. The method of claim 1, wherein the computer processing uses the Root Mean Square method to determine an average sound amplitude of the audio signal, by calculating the square root of the average of the squares of audio samples.

7. The method of claim 6, wherein the audio samples are grouped into data block buffers, each sample being taken, squared and averaged before the square root is extracted to obtain the RMS value.

8. The method of claim 7, wherein the calculated RMS value is multiplied by a predetermined amplification factor, and adjusted to remain in a range between 0 and 1, where any negative value is set to zero and any value greater than 1 is set to 1.

9. The method of claim 6, wherein the calculated RMS value is multiplied by a predetermined amplification factor, and adjusted to remain in a range between 0 and 1, where any negative value is set to zero and any value greater than 1 is set to 1.

10. The method of claim 1, wherein the control of the vibration intensity of the haptic motor is proportional to the adjusted RMS value or to the vibration percentage corresponding to the decibel trunk in which the detected sound level lies.

11. The method of claim 1, wherein the haptic engine is integrated into a smartphone and the vibrations are emitted in real time as a function of variations in the audio signal picked up by the phone's microphone or received from an external audio source.
